(19) United States
(12) Patent Application Publication
(10) Pub. No.: US 2021/0241650 A1
(43) Pub. Date: Aug. 5, 2021

(54) COLLABORATIVE SYSTEM FOR TEACHING DESIGN AND CRITICAL THINKING SKILLS

(71) Applicant: GENESIS, THE SCHLESINGER ACADEMY FOR INNOVATION, Beverly Hills, CA (US)

(72) Inventors: Sheri Lynn Schlesinger, Beverly Hills, CA (US); Daniella Sara Simon, Los Angeles, CA (US); Watson Franklin Hartsoe, III, Los Angeles, CA (US); Lauren Janelle Arshad, Los Angeles, CA (US); Stephanie Angelique Torres, Los Angeles, CA (US); Anthony Assi, Los Angeles, CA (US)

(21) Appl. No.: 17/162,380

(22) Filed: Jan. 29, 2021

Related U.S. Application Data
(60) Provisional application No. 62/968,431, filed on Jan. 31, 2020.

(51) Int. Cl. G09B 19/00; G09B 7/02

(52) U.S. Cl. CPC G09B 19/00; G09B 7/02

(57) ABSTRACT

Systems and methods for teaching critical thinking and design skills by linking art and technology education are described herein. A system can include a collaborative board game that incorporates art and technology elements to guide students through a problem-solution design process. The collaborative board game can be incorporated into a broader educational curriculum for teaching design and critical thinking skills.

### CROSS REFERENCE TO RELATED APPLICATIONS

This application claims the benefit of priority under 35 U.S.C. § 119(e) to U.S. Provisional Application No. 62/968,431, filed on Jan. 31, 2020, entitled “COLLABORATIVE SYSTEM FOR TEACHING DESIGN AND CRITICAL THINKING SKILLS,” the contents of which is hereby incorporated by reference in its entirety.

### FIELD

The present disclosure relates to educational tools for improving design and critical thinking skills.

### BACKGROUND

Critical thinking and design skills are critical to both the creation of art and technological advancement. Proper education in both arenas is important to create intellectually curious and independent thinkers. However, art and technology are often taught and treated as independent concepts. Thus, students of technology may fail to learn the creative thinking skills necessary to produce innovative work and students of the arts may fail to learn and apply the tools of technology to creative works.

### SUMMARY

The systems and methods described herein relate to educational tools for teaching critical thinking and design skills through the integration of art and technology education as connected concepts.

Disclosed herein is a collaborative learning environment that may be virtual and/or in person and is an immersive and interactive learning methodology. Utilizing a curriculum based upon design thinking, students can become problem solvers and creative innovators through the use of art disciplines and emerging technologies.

A system for collaborative learning can include: a plurality of problem cards comprising a representation of a problem to be solved; a plurality of technology cards comprising a representation of a technology; and a plurality of art cards comprising a representation of an art production technique, wherein one or more users identify a technology represented on one or more of the plurality of technology cards and an art production technique represented on one or more of the plurality of art cards to determine a solution to a problem represented on one or more of the plurality of problem cards. The system can include a combination board. The combination board can include: a first area configured to receive one or more of the plurality of problem cards; a second area configured to receive one or more of the plurality of technology cards; and a third area configured to receive one or more of the plurality of art cards. The second area can include: a first technology card location configured to receive one or more of the plurality of technology cards associated with a first user of the one or more users; and a second technology card location configured to receive one or more of the plurality of technology cards associated with a second user of the one or more users. The third area can include: a first art card location configured to receive one or more of the plurality of art cards associated with a first user of the one or more users; and a second art card location configured to receive one or more of the plurality of art cards associated with a second user of the one or more users. The system can include a plurality of voting tokens. The one or more users can identify the technology represented on one or more of the plurality of technology cards and the art production technique represented on one or more of the plurality of art cards by: placing one or more voting tokens on the one or more of the plurality of technology cards; and placing one or more voting tokens on the one or more of the plurality of art cards. The system can include a timer. The one or more users can determine the solution based on said technology and said art production technique within a period of time determined by the timer.

A method of using a collaborative problem-solution board game can include: determining one or more problem cards of a plurality of problem cards, wherein the one or more problem cards comprise a representation of a problem to solve; distributing a plurality of technology cards among a plurality of players, wherein the one or more plurality of technology cards comprise a representation of a technology; distributing a plurality of art cards among the plurality players, wherein the one or more plurality of art carts comprise a representation of an art production technique; identifying one or more technology cards of the plurality of distributed technology cards to utilize in one or more proposals to solve the problem represented on the one or more problem cards; identifying one or more art cards of the plurality of distributed art cards to utilize in the one or more proposals; and determining a winning proposal of the one or more proposals. The method can include determining a player category for each of a plurality of players, wherein the player category comprises at least one of a technology player and an art player.

A method of collaborative learning in a virtual environment can include facilitating access to a plurality of users to a virtual environment; displaying interactive educational content associated with a problem or a technology; receiving a user interaction with the interactive educational content; updating the virtual environment in response to receiving the user interaction; displaying a virtual game associated with at least some of the educational content; receiving a user interaction associated with the virtual game; and facilitating user access to a separate area of the virtual environment to allow group discussion of aspects of the virtual game.

For purposes of summarizing the disclosure, certain aspects, advantages, and novel features have been described herein. Of course, it is to be understood that not necessarily all such aspects, advantages, or features will be embodied in any particular embodiment or example.

### BRIEF DESCRIPTION OF THE DRAWINGS

FIG. 1A shows an example system for collaborative learning.

FIG. 1B shows example card components of the system of FIG. 1A.

FIG. 1C shows an example board component of the system of FIG. 1A.

FIG. 2 illustrates an example solution design process.

FIG. 3 illustrates an example educational process for teaching design and critical thinking skills.

FIGS. 4A-4S illustrate example aspects of a virtual application of the collaborative educational process.

### DETAILED DESCRIPTION

The present disclosure describes example systems and methods for teaching critical thinking and design skills by linking art and technology education. These systems and methods can be implemented in a variety of ways. For instance, an example collaborative board game can incorporate art and technology elements to guide students through a problem-solution design process. The collaborative board game can be incorporated into a broader educational curriculum for teaching design and critical thinking skills.

In some examples, elements of the collaborative board game can be implemented into a virtual environment, facilitating remote collaborative learning for users of the virtual application.

### A. Example System for Collaborative Learning

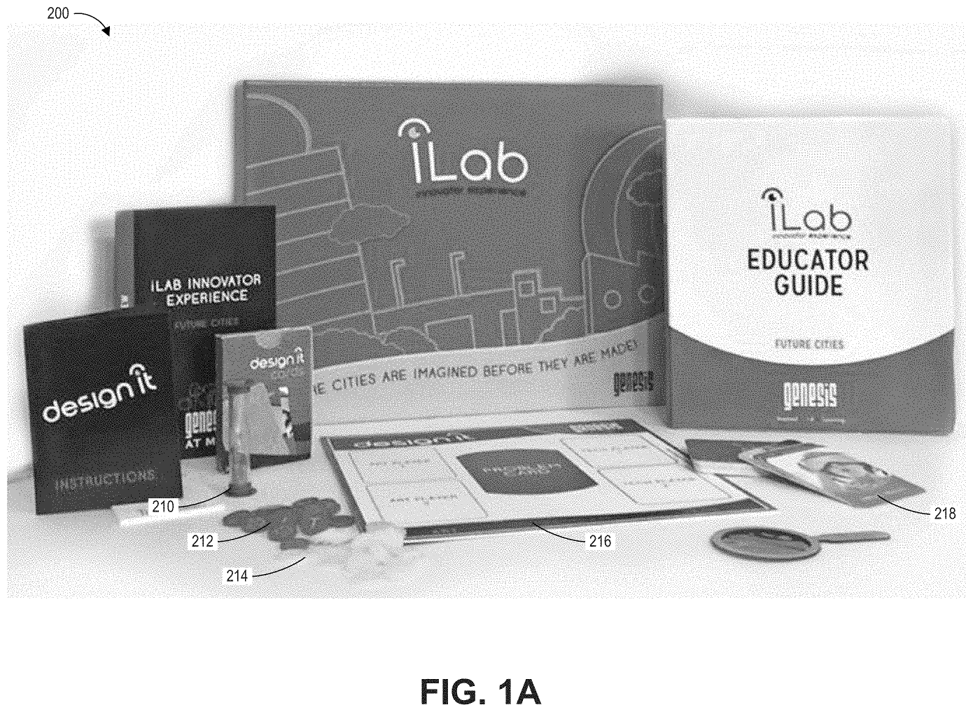

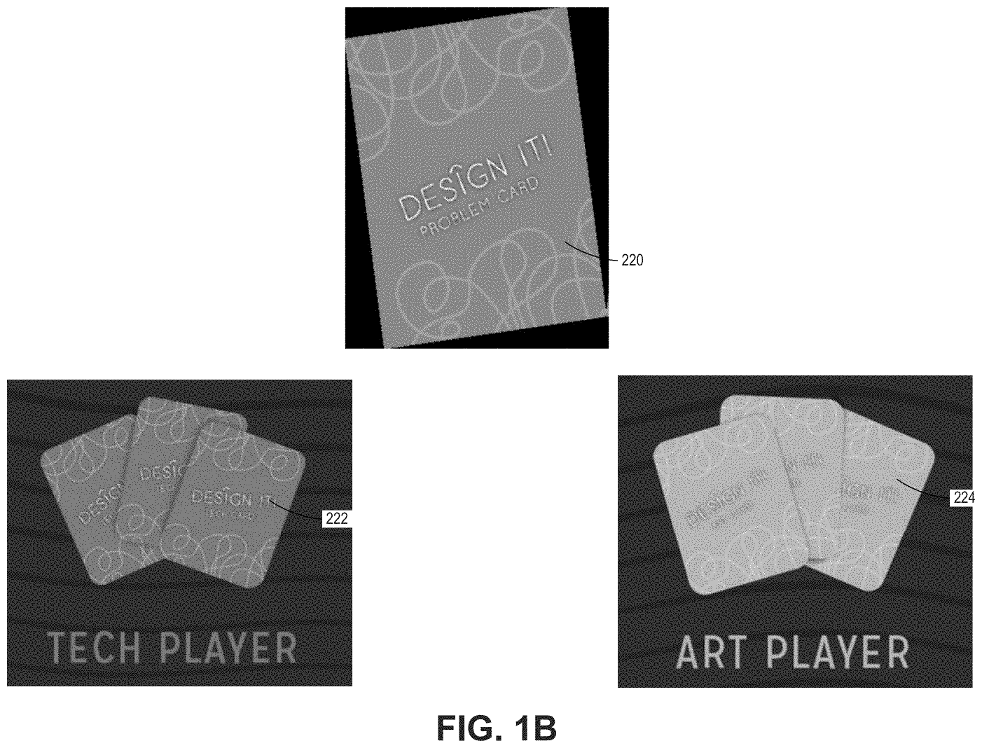

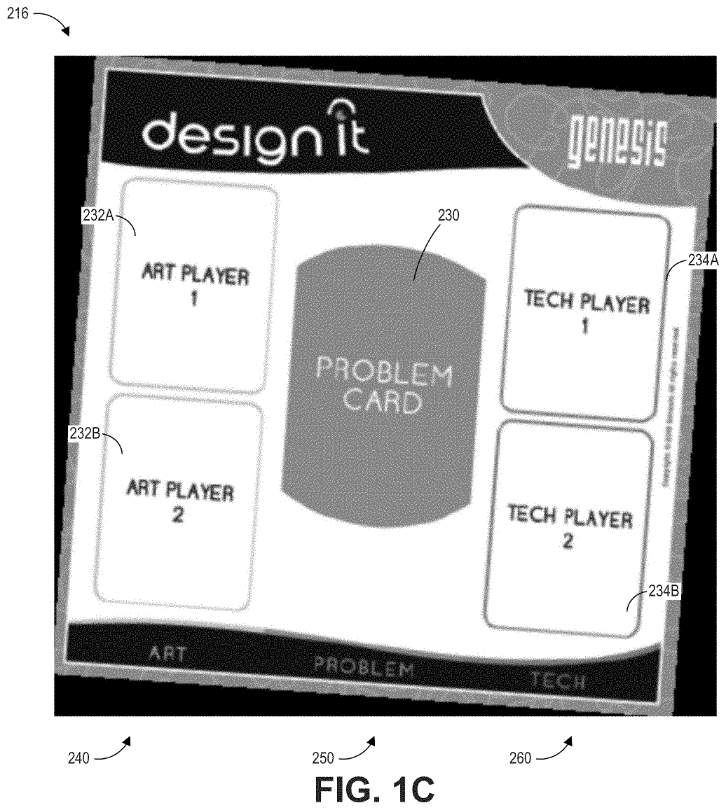

FIGS. 1A-1C illustrate components of an example collaborative board game 200 that may be used as part of an educational process designed to teach critical thinking and design skills. For example, as shown in FIG. 1A the collaborative board game 200 can include a timer 210, technology tokens 212, art tokens 214, a game board 216, and playing cards 218.

The timer 210 can include any suitable device for tracking time. For example, the timer 210 can include an hourglass, a digital timer, stopwatch, the like, or some combination thereof.

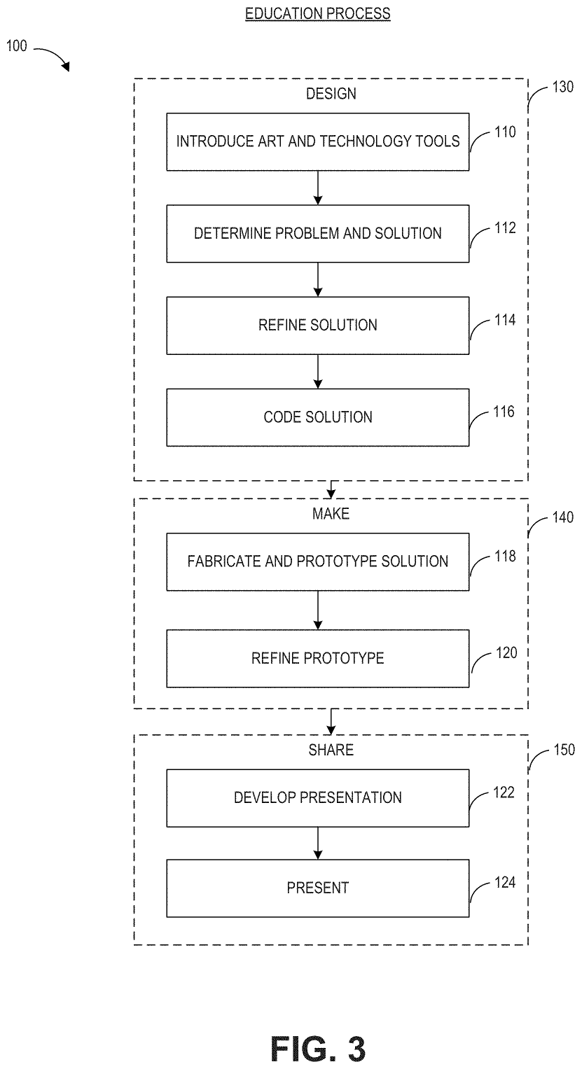

The technology tokens 212 and the art tokens 214 can include tokens suitable for users to vote on a playing card, as is described below with reference to FIG. 3. The technology tokens 212 may include a graphic or color scheme to indicate that the tokens are technology tokens. For example, the technology tokens 212 may include text, such as a “T” for technology, or mirror the color scheme of the technology cards 222, as will be described below. The art tokens 214 may include a graphic or color scheme to indicate that the tokens are art tokens. For example, the art tokens 214 may include text, such as “A” for art, or mirror the color scheme of the art cards 224 as will be described below.

FIG. 1B illustrates example playing cards that may be part of a collaborative board game 200. The playing cards can include one or more problem cards 220, technology cards 222, and art cards 224.

The problem cards 220 can include different societal, cultural, environmental, or other problems. The problem cards can include thematic problems. For example, the problem cards can include problems that may affect “future cities,” such as plastics, extinction, natural disaster, pollution, crime, misinformation, surveillance, accessibility, health, migration, rising population, renewable energy, transportation, waste disposal, drinking water, or corruption. The problem cards 220 can include a problem name and a representative picture. For example, for the problem of natural disaster, the problem card can show the text “natural disaster” and a picture of a storm or flooding. In another example, for the problem of transportation, the problem card can show the text “transportation” and a picture of cars in traffic.

The technology cards 222 can include different types of technology that may be used in a solution to one or more of the problems included on the problem cards 220. For example, the technology cards can include artificial intelligence, internet of things, game design, robots, virtual reality, social media, 3D printing, interactive technology, and wearable technology cards. The technology cards 222 can include a technology name and a representative picture. For example, for the technology of robots, the technology card can show the text “robot” and a picture of an automated machine. In another example, for the technology 3D printing, the technology card can show the text “3D printing” and a picture of a 3D printer.

The art cards 224 can include different types of art forms that may be used in a solution to one or more of the problems included on the problem cards 220. For example, the art cards can include animation, sculpture, light, found material, graphic design, architecture, collage, dance, and music cards. The art cards 224 can include an art form name and a representative picture. For example, for the art form sculpture, the art card can show the text “sculpture” and a picture of sculptural art. In another example, for the art form dance, the art card can show the text “dance” and a picture of a group of people dancing.

The problem cards 220, technology cards 222, and art cards 224 can include color schemes to differentiate the type of card. For example, the problem cards 220 can have a blue color scheme, the technology cards 222 can have a red color scheme, and the art cards 224 can have a yellow color scheme. Advantageously, using colors with distinct color schemes can allow a user of the collaborative board game to quickly identify a card type.

FIG. 1C illustrates an example game board 216 that may be part of the collaborative board game 216. For example, the game board 216 may include one or more problem card locations 230, one or more art card locations 231A, 231B, and one or more technology card locations 234A, 234B. The number of card locations 231A, 231B, 234A, and 234B can correspond to the number of active players of the board game 200.

An art card location 231A, 231B may be in an art area 240 of the board 216. The art area 240 may include a color scheme, graphic, or text that may indicate that one or more art cards 224 should be placed in the art area 240. For example, the art cards 224 may have a yellow color scheme. The art area 240 may mirror the yellow color scheme to indicate that the yellow art cards 224 should be placed in the art area 240.

A problem card location 230 may be in a problem area 250 of the board 216. The problem area 250 may include a color scheme, graphic, or text that may indicate that one or more problem cards 220 should be placed in the problem area 250. For example, the problem cards 220 may have a blue color scheme. The problem area 250 may mirror the blue color scheme to indicate that the blue art cards 220 should be placed in the problem area 250.

A technology card location 234A, 234B may be in a technology area 260 of the board 216. The technology area 260 may include a color scheme, graphic, or text that may indicate that one or more technology cards 222 should be placed in the technology area 260. For example, the technology cards 222 may have a red color scheme. The technology area 260 may mirror the yellow color scheme to indicate that the red technology cards 222 should be placed in the technology area 260.

### B. Example Solution Design Process

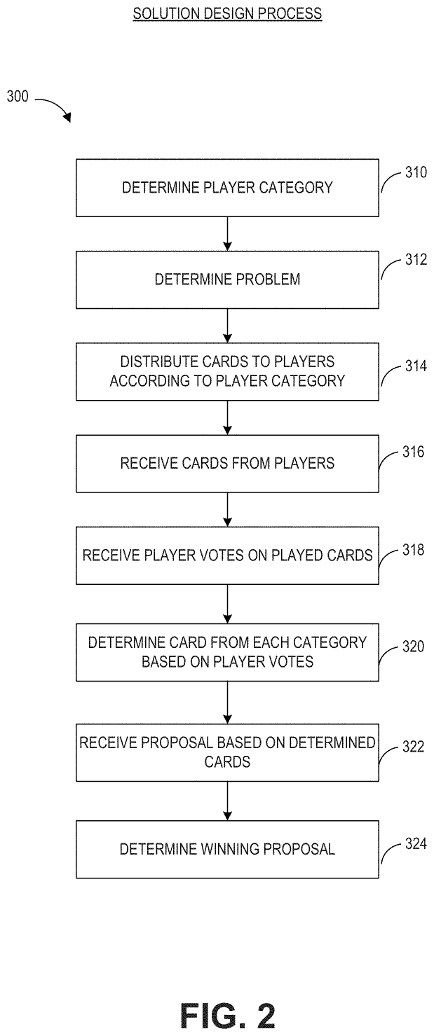

FIG. 2 illustrates an example solution-design process 300 that may be part of an educational process that makes use of the collaborative board game 200. The solution-design process 300 can include a method of playing a game, such as the collaborative board game 200 described with reference to FIGS. 1A-1C.

The solution-design process 300 can include a player categorization block 310, a problem determination block 312, a card distribution block 314, a card receiving block 316, a voting block 318, a card determination block 320, a proposal block 322, and a winning determination block 324.

At a player categorization block 310, players of a collaborative board game 200 can be categorized into categories. Categories can include art players, technology players, and a game master player. The number of art players and the number of technology players can be approximately equal. For example, the total number of players can include 4 players and of those 4, 2 players can be categorized as art players and 2 players can be categorized as technology players. In another example, the total number of players can include 5 players and of those 5, 2 players can be categorized as art players, 2 players can be categorized as technology players, and 1 player can be categorized as “game master”. The categorization can be completed by any suitable means including, but not limited to, self-categorization by players, categorization by a designated player (for example, the “game master” player), categorization by a teacher, random categorization, the like or some combination thereof.

At a problem determination block 312, a problem card can be selected from a set of problem cards. The problem cards can include the problem cards 220 described with reference to FIGS. 1A-1C. A problem card can be selected using any suitable means including, but not limited to selection by a designated player (for example, a “game master” player), by player vote, randomly, the like or some combination thereof. The selected problem card can be placed in a problem area 250 on the game board 216.

At a card distribution block 314, players may receive one or more cards according to their categorization. For example, players categorized as art players can receive art playing cards (for example, the art cards 224 described with reference to FIG. 1B). In another example, players categorized as technology players can receive technology playing cards (for example, the technology cards 222 described with reference to FIG. 1B). Additionally or alternatively, players can receive both technology cards and art cards without deference to player categorization.

At a card receiving block 316, players can play a playing card they received at distribution block 314. For example, the players can select a playing card from the playing cards they received at block 314 and place the selected card onto an appropriate area of the game board 216. For example, a player categorized as an art player may place an art card at an art card location 231A or 231B. In another example, a player categorized as a technology player may place a technology card at a technology card location 234A or 234B. When a player plays their selected card, they may be directed to explain their choice of card as it relates to the problem card. For example, a problem card may be accessibility. A player may play the art card “light.” The player may explain how the art form light can be used to solve the problem of accessibility. In another example, a player may play the technology card “interactive.” The player may explain how interactive technology can be used to solve the problem of accessibility.

At a voting block 318, players can vote on the played cards. For example, voting can include placing tokens on the game board near one or more of the cards placed during block 316. Each player can be given one token for each card category in play aside from the problem card in play. For example, the card categories can include an art category and a technology category. Each player can be given an art token and a technology token. Each player can then place their art token on or near an art card they would like to vote for and place their technology token on or near a technology card they would like to vote for.

At a card determination block 320, a winning set of cards may be determined. For example, an art card and a technology card may be chosen from among the played cards based on the number of votes received for those cards at block 318. Ties between cards may be broken in any suitable manner including but not limited to a second vote or a selection by the game master or teacher.

At a proposal block 322, players may develop a proposal to solve the problem on the selected problem card. The amount of time to develop the proposal may be limited by the timer 210 to ensure that all players have the same amount of time to develop a proposal. For example, the amount of time may be 2 minutes, 30 seconds, 10 minutes, or a suitable time determined by the game master, teacher, other player. The players may develop a proposal by analyzing the winning set of cards from block 320 to determine how the concepts on the winning set of cards can be used to solve the problem on the selected problem card. In some examples, the players may draw their proposal. In other examples, the players may write down their proposal. In other examples, the players may verbally brainstorm their proposal.

At a winning determination block 324, players may determine a winning proposal in any suitable manner. For example, to determine a winning proposal, the players may explain their proposals developed at block 322 to the other players and players may vote on the proposals. The proposal with the highest number of votes can be selected as the winning proposal. Ties between cards may be broken in any suitable manner including but not limited to a second vote or a selection by the game master or teacher.

### C. Example Educational Process

An educational process or method of teaching critical thinking and design skills can include project-based learning using the collaborative board game 200. In project-based learning, one or more users identify a problem and develop a solution to the problem. Advantageously, a project-based structure can allow students to more fully engage in the educational process. FIG. 3 illustrates an example educational process 100 for teaching design and critical thinking skills with the incorporation of a collaborative board game. The example educational process 100 can include one or more educational phases. For example, the one or more educational phases can include a design phase 130, a make phase 140, and a share phase 150.

The design phase 130 can include steps for doing various aspects of choosing designing a solution to a problem, including but not limited to choosing a problem to solve, searching for resources to design a solution to the problem, and organizing the solution. The process 100 can include a segmented curriculum to guide students through those various aspects of the design phase 130. For example, the segmented curriculum can include an introduction block 110, a problem determination block 112, a solution refining block 114, and a coding block 116.

At an introduction block 110 of the design phase 130, a user (for example, a student) can be familiarized with educational content or various aspects of the educational process 100. The educational content can include materials related to the collaborative board game. Advantageously, the introduction of materials related to the collaborative board game prior to playing the game (for example, in block 112) can allow users to more fully engage in the game because the users will have better familiarization with game concepts.

The educational content can be in the form of components of the collaborative board game, such as the board game described with reference to FIGS. 1A-1C. For example, the educational content can be playing card components. As described below, playing cards that may be part of a collaborative board game can have different categories, such as an art category or a technology category. Each card can include information relating to a different art or technology concept.

The educational content, such as the collaborative board game, introduced at introduction block 110 can include various educational concepts. For example, the educational content can include art related content and technology related content (for example, art and technology cards from the board game). The art related content can include information associated with art forms, such as animation, sculpture, light, found material, graphic design, architecture, collage, dance, music, the like, or some combination thereof. The technology related content can include information associated with types of technology, such as artificial intelligence, internet of things, game design, robots, virtual reality, social media, 3D printing, interactive technology, wearable technology, the like, or some combination thereof.

At the introduction block 110, a user can familiarize themselves with introduced concepts (for example, the art or technology concepts included on the playing cards) by identifying the concepts or examples of the concepts in educational materials. For example, the familiarization process can be include researching the concept, identifying the concept in educational materials provided to the user, identifying examples of the concept, the like, or some combination thereof. The educational materials for identifying the concept can include posters, found materials, books, internet materials, the like, or some combination thereof. In some examples, identifying examples of the concept can include identifying specific pieces of art that make use of an art concept on a playing card or identifying pieces of technology that can or do make use of a type of technology on a playing card. For example, a playing card may include the concept of sculpture and the user may identify that the statute of liberty is an example of the art form sculpture. In another example, a playing card may include the concept of architecture and the user may identify that the Walt Disney Hall in Los Angeles is an example of the art form architecture. In another example, a playing card may include the concept of 3D printing and the user may identify that small houses can be constructed using the technology of 3D printing. In another example, a playing card may include the concept of wearable technology and the user may identify that a fitness tracker is an example of wearable technology.

In another example, at the introduction block 110, an educator can familiarize the user by providing examples of the concepts. For example, the educator can provide stories of utilizing various concepts related to art and technology, such as entrepreneurial start-up stories. In another example, the educator can provide examples of art forms, such as paintings, architecture, sculpture or dance. In another example, the educator can provide examples of technology, such as wearable technology or 3D printing.

At a problem determination block 112 of the design phase 130, one or more users can participate in a problem-solution process. For example, one or more users can participate in a collaborative board game that may take the user through aspects of a problem-solution process, as will be described in detail below with reference to FIG. 3. An outcome of the problem determination block 112 can be an identified problem to solve and an initial solution.

At a solution refining block 114 of the design phase 130, a user can perform various processes to investigate the identified problem and initial solution that may be an output of block 112. For example, a user can organize the initial solution into a more refined solution through a storyboarding activity. The storyboarding activity can include steps to elaborate on the initial solution by, for example, brainstorming how to implement the initial solution, drawing ideas related to the problem and initial solution, researching the information associated with the problem and initial solution, or discuss questions provided on worksheets containing information related to the identified problem or aspects of the initial solution.

At a coding block 116 of the design phase 130, a user can learn about computer code or develop computer code for their solution. The user can develop computer code by assembling code statements on a codeboard. The codeboard can contain a more detailed version of the storyboard from solution refining block 114 together with code words attached to each step of the drawing. In some examples, the user(s) can create multiple codeboards for different aspects of the problem-solution process. For example, a user can create a codeboard for the identified problem, a prototype solution, and an anticipated future. The codeboard can include if-then statements. For example, where the codeboard is a problem codeboard and the problem is accessibility, the codeboard could include if-then statements about accessibility, such as “if there is traffic and a blind person walks towards it, then the blind person is injured.” In another example, where the codeboard is a prototype codeboard and the solution is the art form “light” and the technology “interactive,” the codeboard could include if-then statements relating to the solution based on how interactive technology and light could solve accessibility, such as “if a blind person walks towards traffic, the walking stick will detect the traffic and light up and voice a recording, ‘Danger Traffic Alert,’ then cars will see the flashing light and stop, and the blind person will cross safely.” In another example, where the codeboard is a prototype codeboard and the solution is the art form “light” and the technology “interactive,” the codeboard could include if-then statements relating to the solution based on how interactive technology and light could solve accessibility, such as “if a blind person walks towards traffic, the walking stick will detect the traffic and light up and voice a recording, ‘Danger Traffic Alert,’ then cars will see the flashing light and stop, and the blind person will cross safely.” An outcome of the coding block 116 can include a design solution that may be in the form of code on a codeboard.

The make phase 140 can include steps for doing various aspects of making or creating a solution designed in the design phase 130, including but not limited to developing a solution, documenting the solution, and coordinating the solution. The process 100 can include a segmented curriculum to guide students through various aspects of the make phase 140. For example, the segmented curriculum can include a fabrication block 118, and a prototype refining block 120.

At a fabrication block 118 of the make phase 140, a user can develop a prototype of their solution. For example, the user can use developed storyboards or codeboards to make a prototype using gathered materials. An educator can provide guidance to the user with regard to types of materials or technologies that would be most appropriate for building projects. In some examples, an educator can expose the user to examples of art or technology in use in order to aid the user's understanding of their problem and solution. An output of the fabrication block 118 can include a prototype.

At a prototype refining block 120 of the make phase 140, a user can refine their prototype by testing and producing different versions of the prototype. An educator can encourage a user to refine the prototype by sharing examples of product development and improvement. For example, an educator can show a student the variations in mobile phone design over the course of a decade and discuss the changes between designs to improve functionality, ease of use, presentation, or other aspect of the product design. The user can then apply the learned principles of improving a product to improving their prototype. An output of the prototype refining block 120 can include a more refined version of the prototype developed in fabrication block 118.

The share phase 150 can include steps for doing various aspects of sharing information relating to the design phase 130 or make phase 140, including but not limited to reflecting on the design phase 130 and make phase 140, following up on the solution, and sharing information relating to the problem and solution. The process 100 can include a segmented curriculum to guide students through various aspects of the share phase 150. For example, the segmented curriculum can include a presentation development block 122 and a presentation block 124.

At a presentation development block 122 of the share phase 150, a user can develop a presentation to communicate information regarding their prototype. An educator can provide information relating to successful or unsuccessful communication. For example, an educator can introduce stories relating to successful marketing campaigns or the principles of good communication. The user can then implement the concepts highlighted by the educator relating to good communication in a presentation, such as a pitch, skit, poster, the like, or some combination thereof.

At a presentation block 124 of the share phase 150, a user can share their presentation developed in block 122 with the educator or other users.

It will be appreciated that while various blocks and examples are described as occurring at certain points in an education process 100, the blocks can be incorporated at any point in the education process 100 and aspects of the blocks can be included at any point in the education process 100.

### D. Example Virtual Application of a Collaborative Learning System

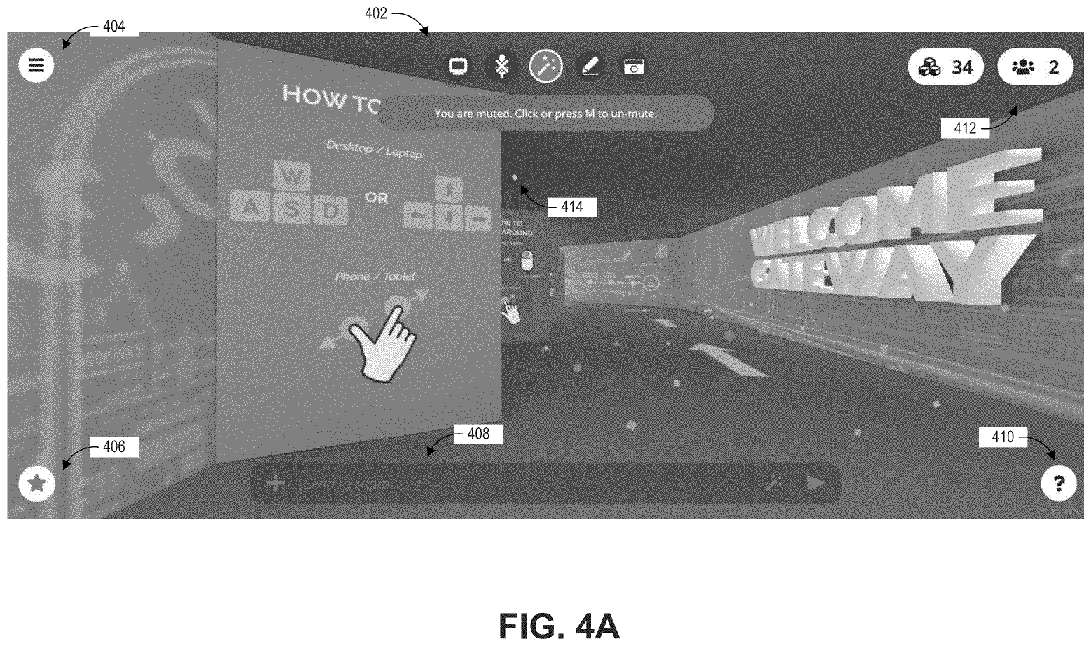

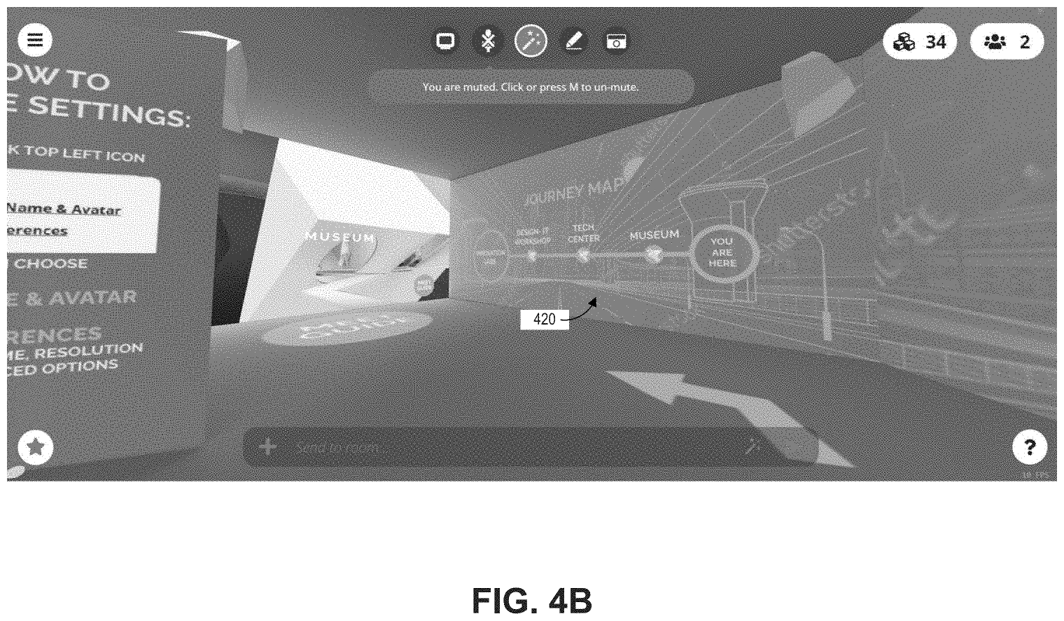

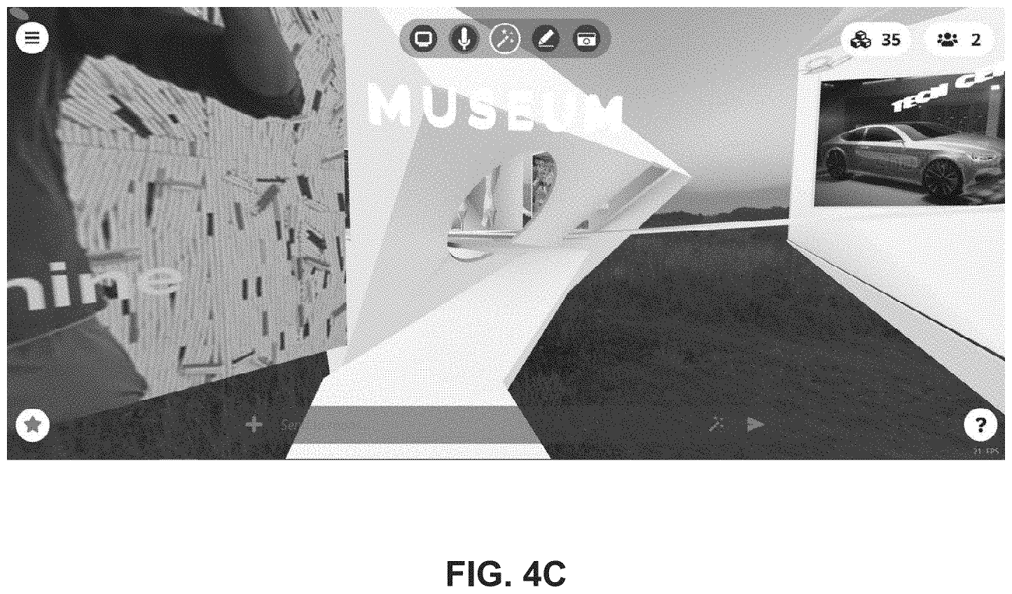

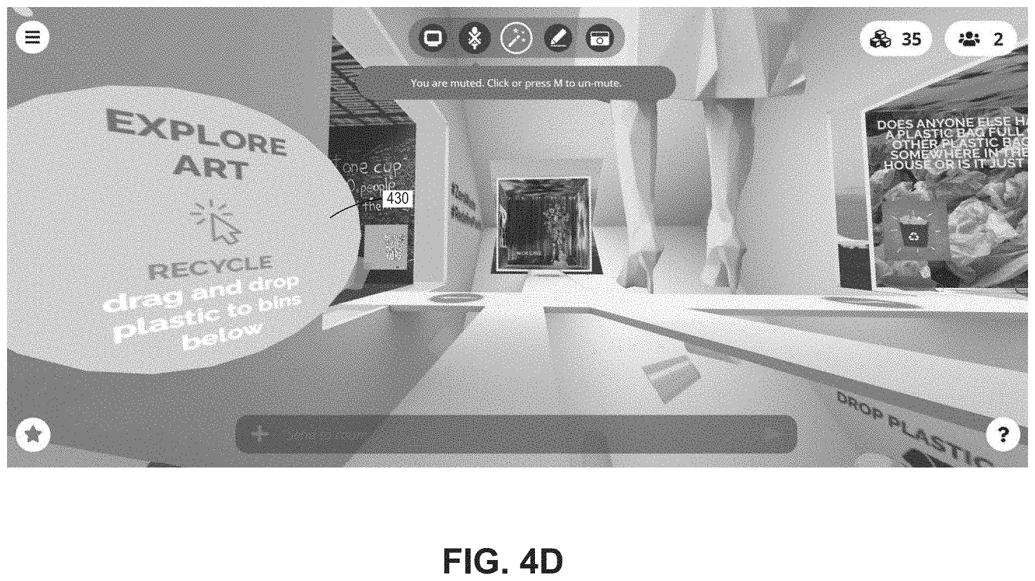

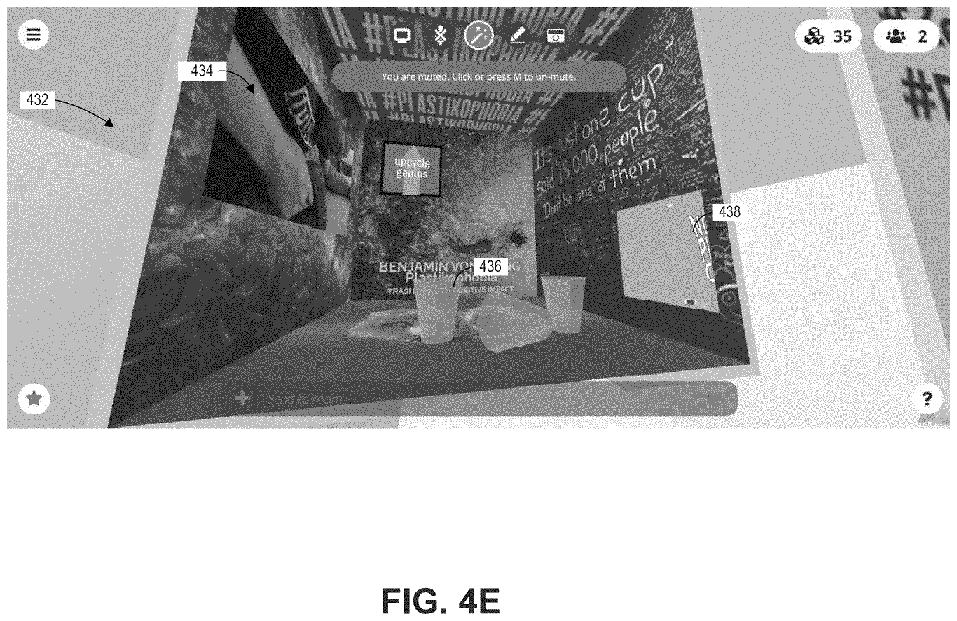

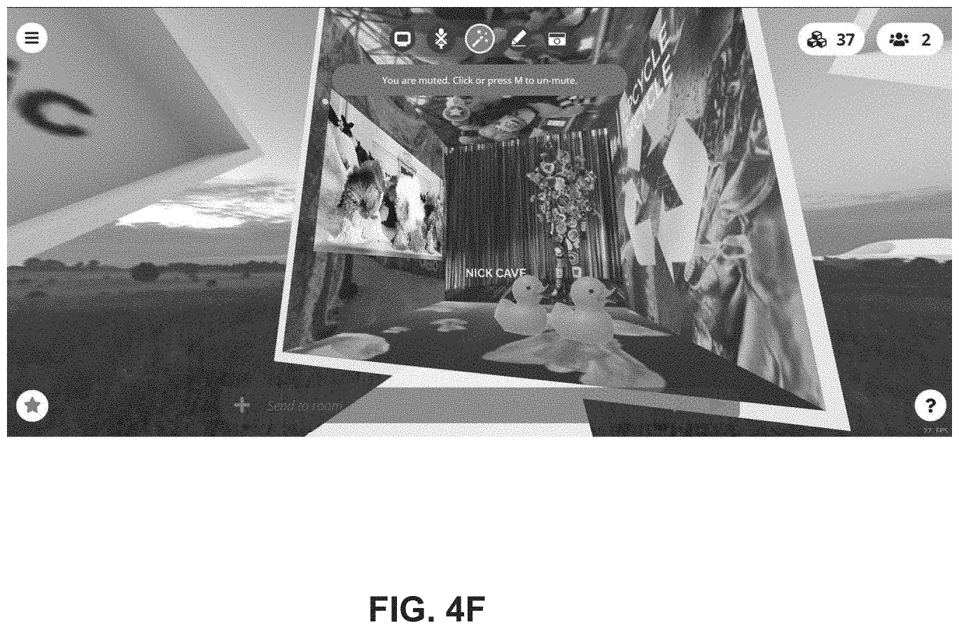

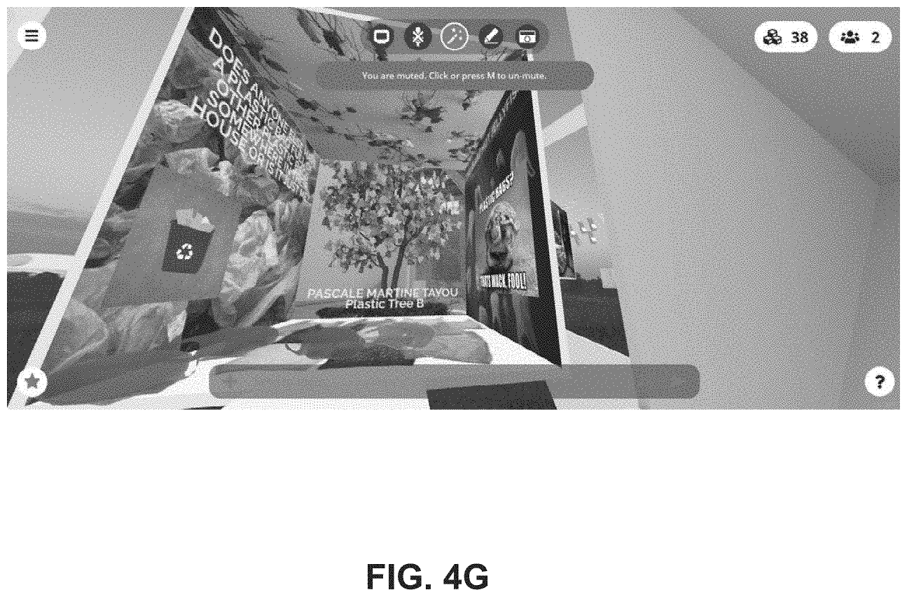

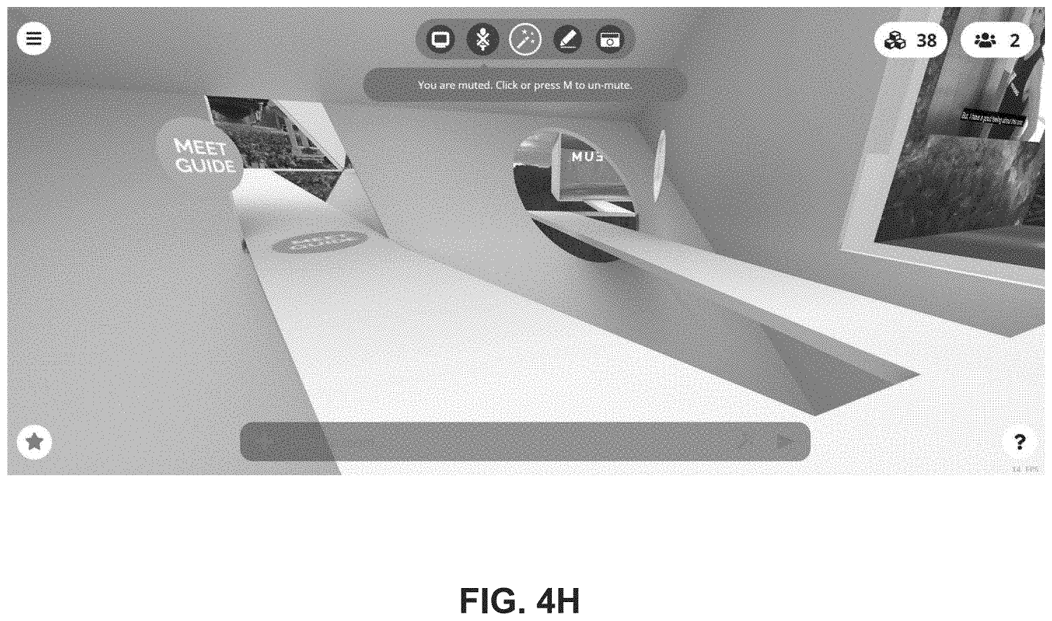

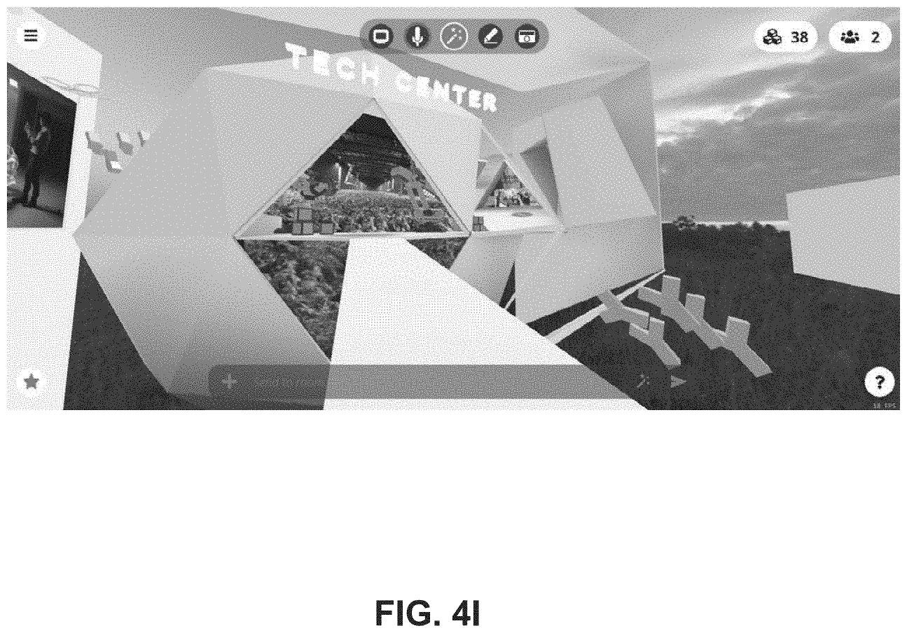

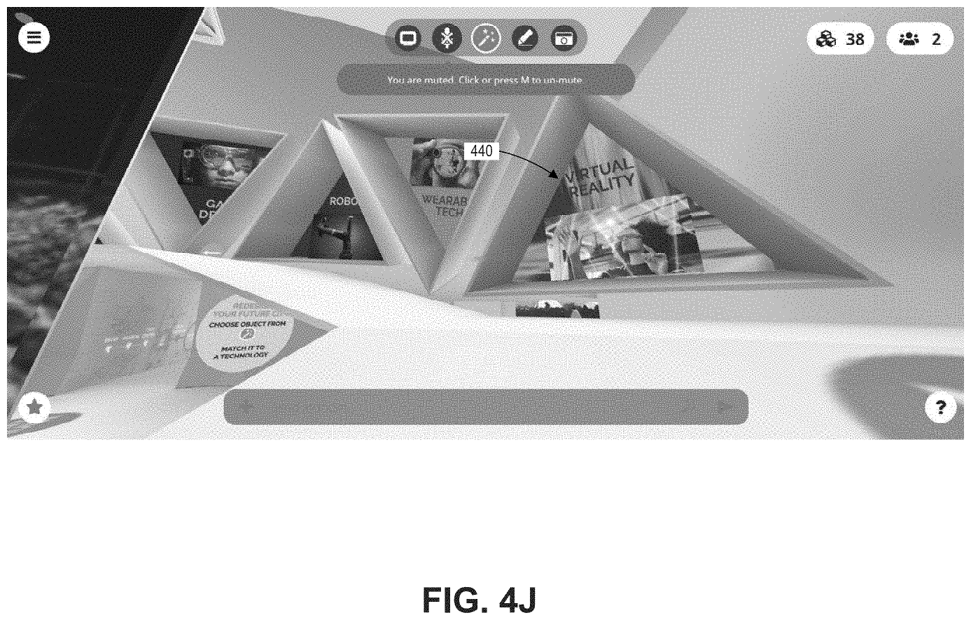

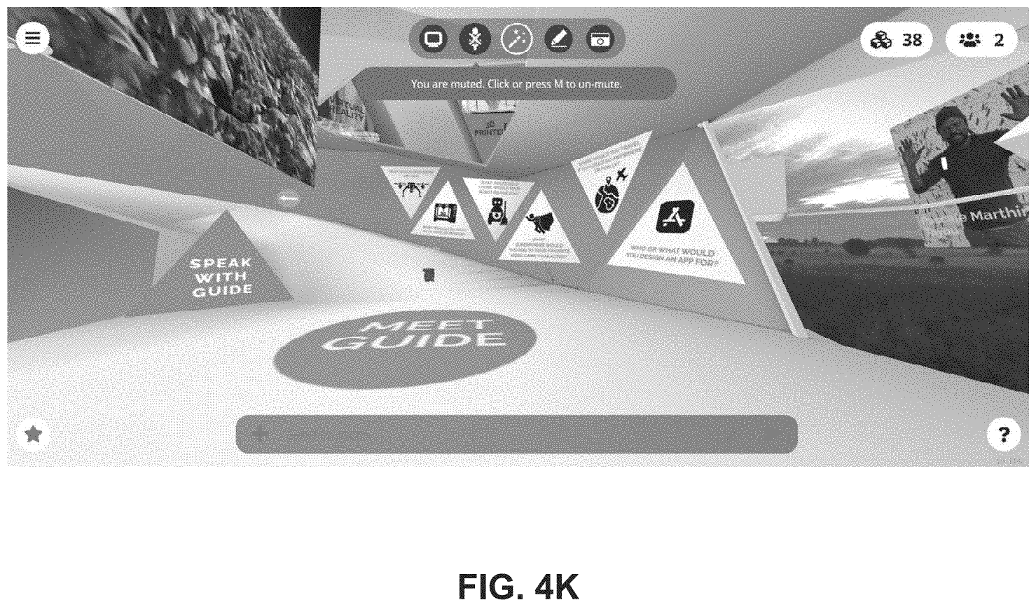

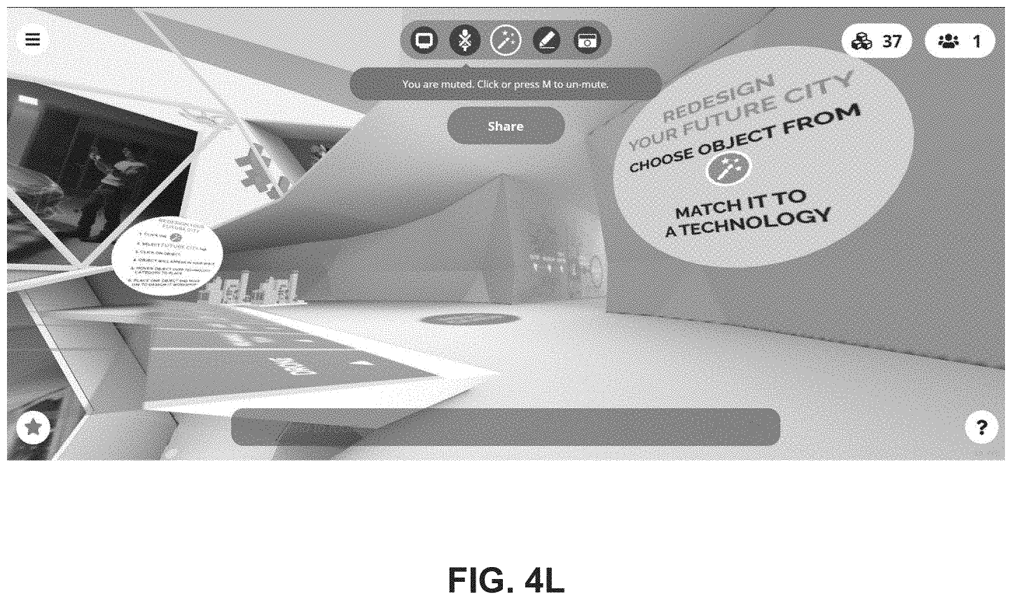

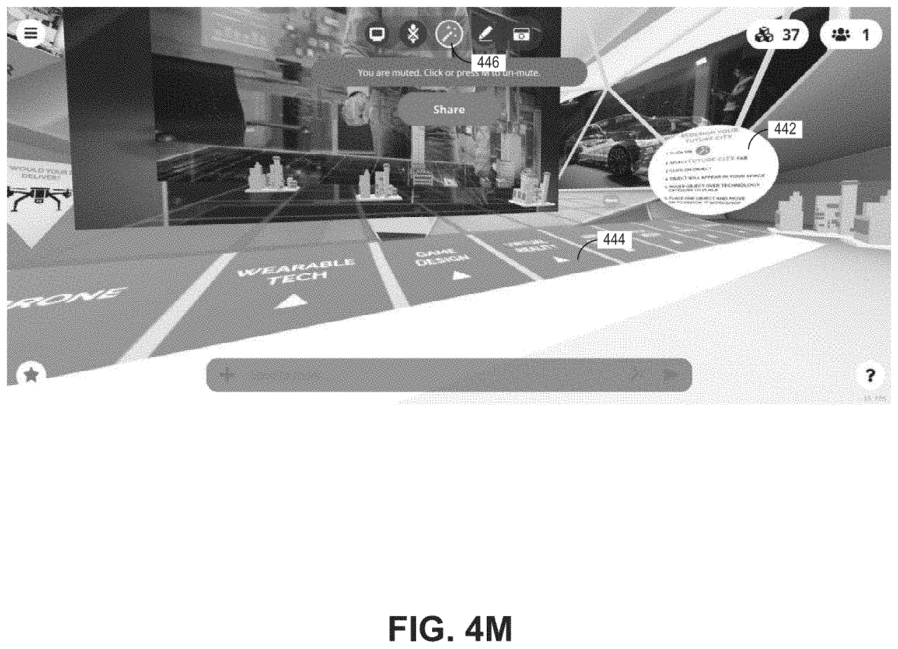

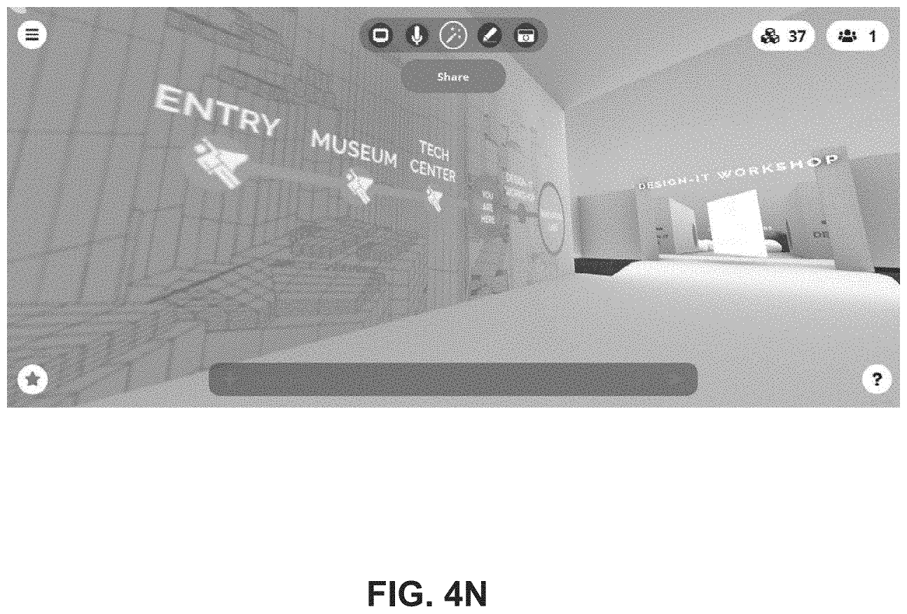

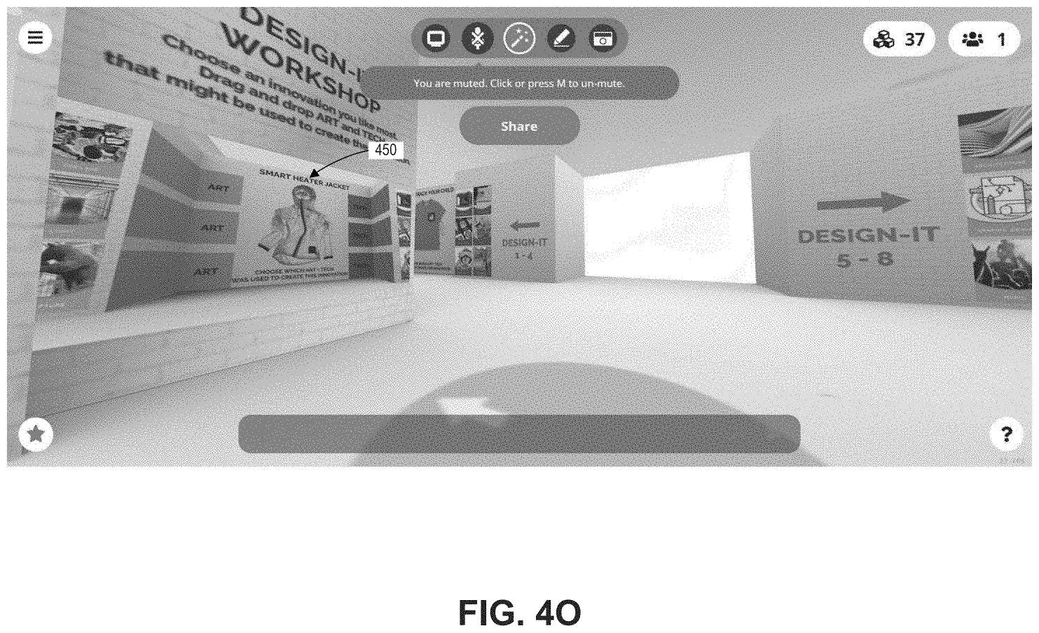

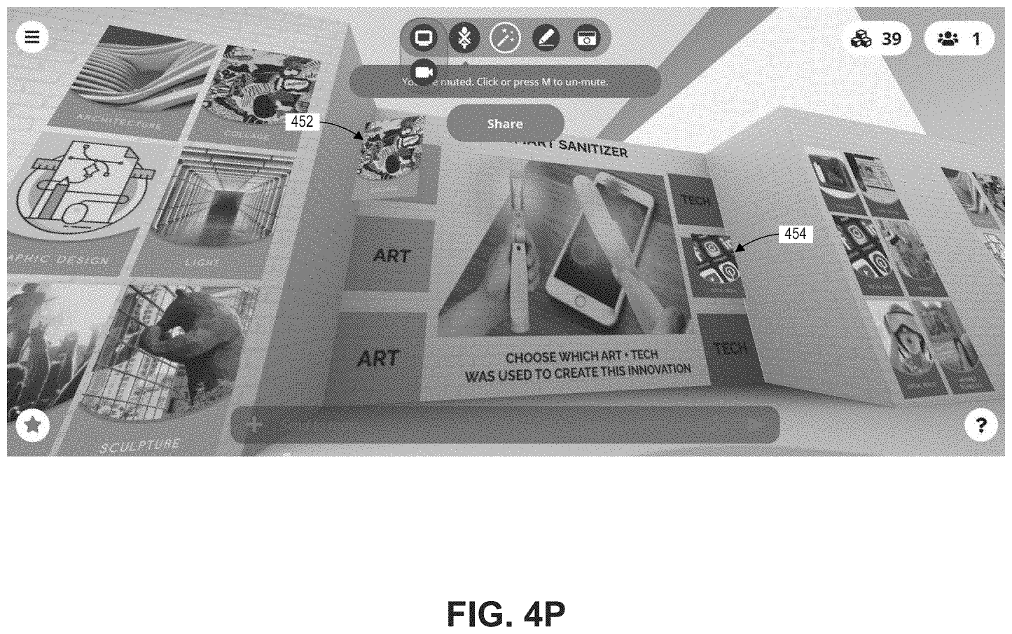

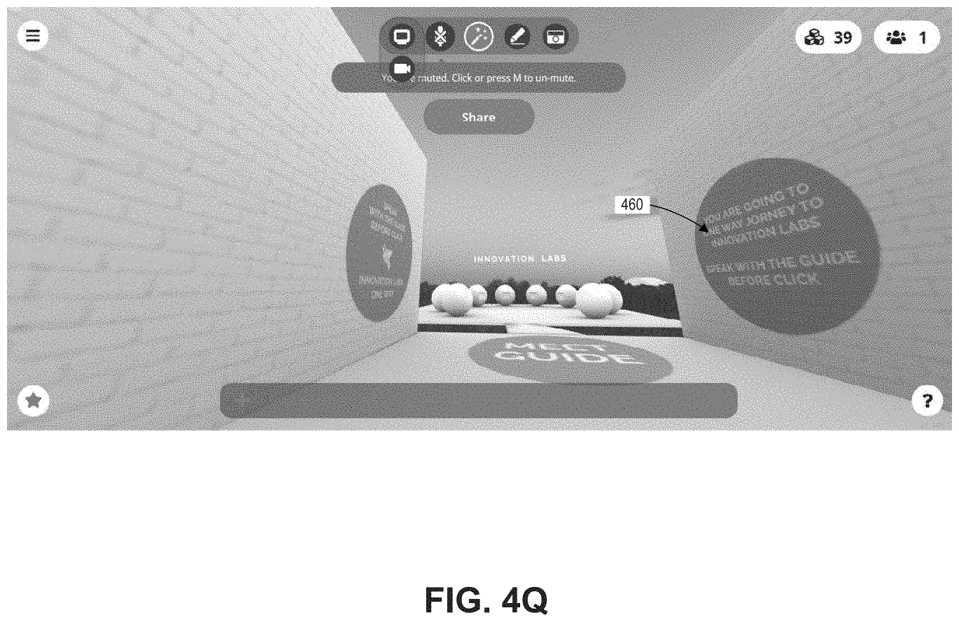

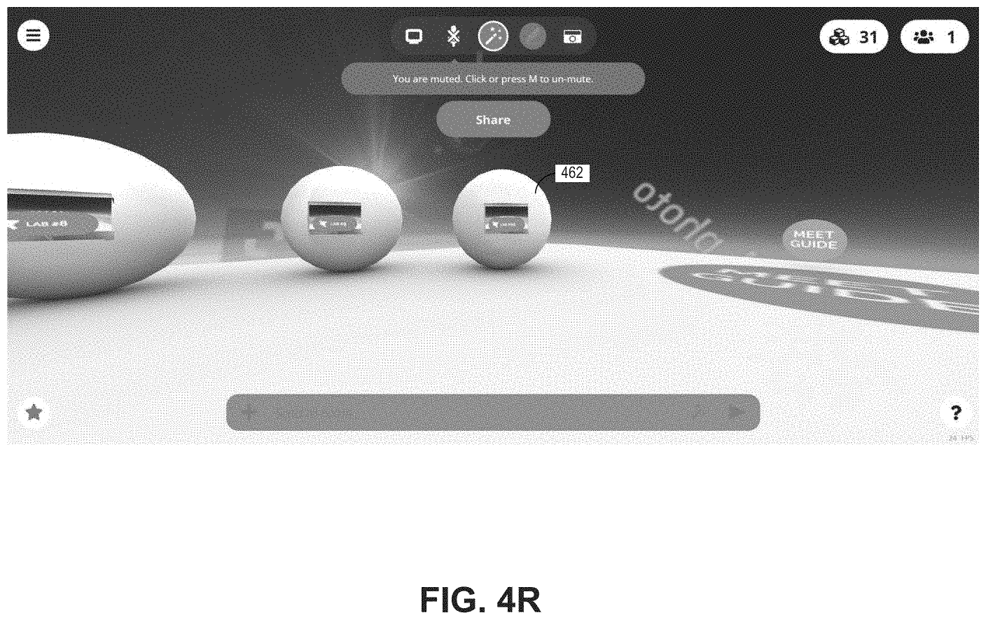

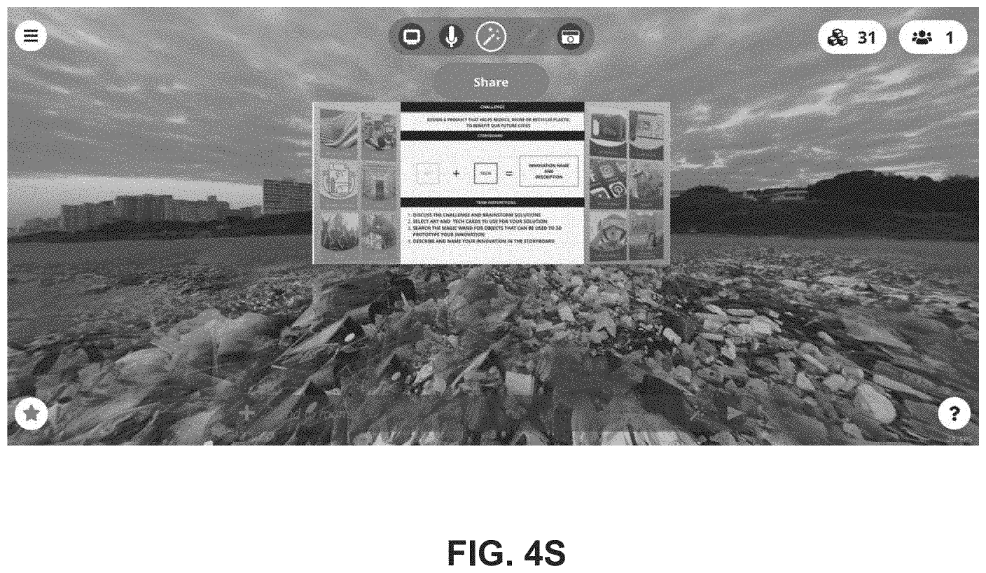

FIGS. 4A-4S illustrate aspects of an example virtual application of a collaborative learning system. One or more aspects described above (of, for example, a collaborative board game and curriculum) may be incorporated into a virtual environment that may be configured to allow users to interact with other users, interact with virtual objects and virtual content, download or upload content, and complete educational exercises. Users may be given a timed or untimed experience within areas of the virtual environment or within the entire virtual environment. In some examples, a virtual guide (which may include AI or be controlled by a human) may interact with users within the virtual environment to guide the user through the educational experience. The virtual environment may include entirely open areas for exploration or restricted areas of exploration that may be opened by the guide or user with permissions (such as an educator) or as users access and complete content.

While a certain type and application of content within the virtual environment is illustrated herein, other content and curriculum pathways may also be used. In some examples, a virtual collaborative environment may include a customizable platform with default options for educational content that may be updated with educator specific content. In some examples, a virtual collaborative environment may be customized according to educator preferences. For example, an educator or content creator may generate a virtual collaborative environment to mimic exhibits and educational resources available in a real life museum collection or a real life classroom. Thus, users may be able to curate a virtual field trip to a museum with museum specific educational content. In some examples, a virtual collaborative environment may include a plurality of content options that may update activity and available content based on educational goals, target educational age group, class size, other educational related parameters, the like or a combination thereof.

A virtual environment may include a user interface or portal to interact with the environment. For example, as illustrated in FIG. 4A, a user interface may include a plurality of interactable components, such as an interaction bar 402, menu button 404, favorites button 406, chat box 408, help button 410, interface information button 412, and cursor 414. In some examples, an interaction bar 402 may include a plurality of buttons for common actions, such as screen sharing, video or audio and microphone muting or volume control, edit actions, camera or screen grabbing actions, and content lookup, download, or upload options. In some examples, a menu button 404 may open a menu of options when interacted with by a user via, for example, a cursor 414. In some examples, a favorites button 406 may open favorite content or other favorite interface options when interacted with by a user via, for example, a cursor 414. In some examples, a chat box 408 may accept user input and facilitate textual, graphical, or audible communication with other users. In some examples, a help button 410 may facilitate access to information about the interface or access to help information or another user that may provide help. In some examples, an interface interaction button 412 may provide information associated with the interface, such as the number and type of interactable objects, the number of users present, the type of users, the like or a combination thereof. A cursor 414 may include a graphical representation of a user focus. In some examples, the cursor 414 may be a circle, wand, arrow, or other graphic.

In some examples, such as illustrated in FIG. 4a, a virtual environment may include a navigation practice space, which may include instructions on how to interact with the virtual environment in a main space. In some examples, users may be granted unlimited time to explore and practice new skills within the practice space. The practice space may include information on avatar navigation, familiarity, and skills. Users may be allowed to master movement, speech, a interactive tools needed to properly participate in collaborative learning in the main space. In some examples, users may be given a game, set of tasks, or quiz designed to teach users how to navigate the main space before moving to the main space. Allowing for unlimited advance time may allow users of all skill levels to become comfortable in interacting with the virtual environment and enhance the ability of users to participate in collaborative learning.

FIG. 4b illustrates an example introduction area of a virtual environment that may include instructions and/or introductory material for the virtual environment. In some examples, an introduction area may include a journey map 402. The journey map 402 may include information associated with the virtual space, such as a map of the virtual environment. The virtual environment may be set up so that a user is introduced to educational components in an order similar to the curriculum described above. The map may illustrate the order that the user will encounter areas in the virtual environment. For example, a curriculum can include a design phase, wherein users are first introduced to art and technology tools, taught to determine problems and solutions, and refine solutions to the problems. The map may illustrate locations of the design phase area on the map or illustrate a timeline of how a user may experience design phase areas of the map. In another example, a curriculum can include a make phase, wherein users are taught to fabricate and prototype a solution and refine the prototype. The map may illustrate locations of the make phase area on the map or illustrate a timeline of how a user may experience make phase areas of the map. In another example, a curriculum can include a share phase, wherein users are taught to develop a presentation and present their presentation. The map may illustrate locations of the share phase area of the map or illustrate a timeline of how a user may experience share phase areas of the map. In one example, as illustrated, a journey map 420 may illustrate areas of a virtual environment, including a museum, technology center, and workshop area. In some examples, the introduction area may include a video or other content to introduce concepts associated with the virtual environment or content included in the virtual environment.

FIGS. 4c-4s illustrate example views of an example virtual environment. Aspects or areas of the virtual environment may be combined or presented in a different or the same order as described herein or have more or fewer components, rooms, content, the like or a combination thereof.

FIGS. 4c-4h illustrate views of an example museum area of a virtual environment. A museum may include rooms or areas where users can view and interact with educational content relating to ideas associated with the problem and solution students may be prompted to consider and address later in an educational program. FIG. 4c shows an initial area for a museum area of a virtual environment. FIG. 4d illustrates an entrance area for a museum area of a virtual environment. The entrance area may include instructions 430 for how to interact with objects and content in the museum. FIG. 4e illustrates an example first education area 432. The education area 432 may include a video 434 or other educational content configured to teach users about a first problem to be addressed and an interactive activity associated with the first problem. For example, in the illustrated example, a problem can include pollution. The video can teach about issues of pollution. In some examples, the interactive activity can include an interaction with virtual content 436. In the illustrated example, users are given the ability to move trash or plastic cups into a recycling area 438. FIGS. 4f and 4g illustrate example variations of the education area 432 with a similar pollution theme. The variations can include representations of art related to the problem across multiple art disciplines. For example, FIG. 4f illustrates an example of toy pollution and rubber ducks. FIG. 4g illustrates an example of plastic bag pollution and plastic bags. In some examples, different education areas 432 may display different problems or variants of the same problem. In some examples, users may be split into groups by a guide and directed to enter different education areas to learn about different problems. Accordingly, students may be introduced to a problem for solving in later portions of the curriculum or virtual environment. FIG. 4h illustrates an example exit area of the museum where students may be instructed to meet a guide before moving on to the next or another area.

FIGS. 4i-4m illustrate views of an example technology center area of a virtual environment. A technology center may include rooms or areas where users can view and interact with educational content relating to ideas associated with technologies may be prompted to consider and address later in an educational program. FIG. 4i shows an initial area for a technology center of a virtual environment. FIG. 4j illustrates an example education area 440. The education area 440 may include a video or other educational content configured to teach users about a first technology or solution and/or an interactive activity associated with the first technology or solution. For example, in the illustrated example, a technology or solution can include virtual reality, wearable technology, or robotics. The video can teach about the technology. In some examples, the interactive activity can include an interaction with virtual content relating to the technology. A technology center may educate users about a plurality of technologies.

FIGS. 4k-4m illustrates an example exit area of a technology center. As illustrated in FIG. 4k, an exit area may include an area to meet a guide or educator to discuss the content learned or visited so far in the virtual environment. In some examples, an exit area may include prompts or questions for discussion relating to the content of the virtual environment encountered so far.

FIGS. 4l and 4m illustrates views of an example activity area associated with the technology center. The activity area may include instructions 442 configured to instruct a user on what actions to perform to complete the activity. In some examples, the activity may include download content using a magic wand button 446. The user may then select content to bring into their virtual environment and place that content onto an area 444 that they would like to pursue in a design phase.

FIGS. 4n-4p illustrate views of an example workshop area of a virtual environment. A design workshop area may include rooms or areas where users can collaboratively develop solutions to problems and work through the design process in the education program. FIG. 4n shows an initial area for a workshop area of a virtual environment. FIG. 4o illustrates an entrance area for a workshop area of a virtual environment. The entrance area may include instructions 450 for how to interact with objects and content in the workshop area, including, but not limited to how to play aspects of a collaborative board game, similar to that described above with reference to FIGS. 1a-2. FIG. 4p illustrates an example virtual collaborative board game. Areas of workshop area may be associated with different problems to be addressed. Users may be guided to different problems so as to collaborate in groups on solutions to problems. In some examples, problem areas may be chosen in a similar manner as problem cards as discussed above with relation to FIGS. 1a-2. Students may select art cards 452 and technology cards 454 or other virtual solution cards or content to use to create solutions to the problem illustrated in the problem area. Selection of the cards or content may be completed in a similar manner as selection of cards discussed above with relation to FIGS. 1a-2. An end result of the activity may include a winning proposal, such as discussed above with reference to FIGS. 1a-2. Once users have a winning proposal, they may be guided to an innovation workspace.

FIGS. 4q-4s illustrate views of an example innovation lab workspace that may be part of a workshop area of a virtual environment. A design workshop area may include rooms or areas where users can collaboratively develop solutions to problems and work through the design process in the education program. FIG. 4n shows an initial area for a workshop area of a virtual environment. FIG. 4o illustrates an entrance area for a lab area of a virtual environment. The entrance area may include instructions 460 for how to interact with objects and content or what activities to perform in the lab area. FIG. 4r illustrates an example lab introductory area where users can choose smaller rooms or labs 462 to privately collaborate with other students. In some examples, the lab introductory area can include an area to meet a guide and discuss educational concepts and activities to perform in the lab(s). In some examples, students and/or teachers may be able to move between rooms or labs. For example, a teacher user may be able to move between labs 462 to check on students. FIG. 4s illustrates an example lab area that a user may enter by clicking on a room or lab 462, such as illustrated in FIG. 4r. In some examples, the lab area may include instructions, a reproduction of the collaborative board game, and/or other virtual content that users may use to collaborate on solutions and participate in aspects of a design and/or make phase of a curriculum, such as described above with reference to FIGS. 1a-3.

### E. Example Use of a Virtual Environment

In some examples, students may begin an interactive session with the virtual environment with a video explaining how they will learn to become inventors and innovators on the virtual “campus”. They may watch an overview of their journey to give context for what they will do and are introduced to the problem they will be asked to solve, or the challenge. In some examples, there may be an avatar guide. They see how an avatar guide will greet them in a series of docent led spaces, before entering the innovation lab space to demonstrate with their team, a solution to the challenge posed.

Users may be able to explain content, set expectations and frame tasks for the experience, pre-view spaces to build familiarity for the student's journey, view narrated video of the challenge they will be tasked with, building empathy, explain the role of the docent avatar, and explain when and how they will collaborate in teams. An impact of the introduction may to be build excitement and set expectations for the experience and make the challenge personal and relatable.

Students may be allowed to participate in activities in a virtual reality art gallery or museum, created with works specific to the challenge. The art gallery may include pieces of art across multiple disciplines. The pieces selected help create an understanding of art as a language of communication and impact. Displaying multiple disciplines, the experience enriches the student's empathy for the challenge. The virtual content may help users explore how artist's speak to the specific challenge they are about to work on, using mediums that communicate on multiple levels their point of view. As a result of interacting with the experience, users will be able to engage with renowned art through a new immersive and interactive experience, build empathy through the artist's works and messages, expand knowledge of the problem, broaden their minds for the challenge, understand that art can reach wide audiences, inspiring political and social change, and gain exposure to a multitude of art mediums and disciplines. An impact of the experience may include expanded understanding of artist techniques of communicating, exposure to art relevant to the challenge, and an enhanced realization of value of viewing art

Students may be allowed to view and interact with exhibits in a technology center area of a virtual environment, learning the many ways technology can be adapted or repurposed for invention and innovation. They may participate in a brainstorming session with live docent led prompts, completing this space with a building exercise. Through the technology center area, users will be able to identify eight technologies and their potential emerging uses, participate in virtual group discussion and brainstorming, sparking creativity and imagination, gain a broader understanding of technology applications, and understand broad technology integration potential for Future Cities. An impact of the experience may include enhanced understanding of technology uses and flexibility, gain an appreciation and value of group discussion for ideation, and gain an enriched ability to imagine diverse technology applications.

Students may be presented with solutions that have been created through inventions or innovations in a workshop area of the virtual environment. In the workshop area, Students may be challenged to analyze a plurality of different products through the lens of a plurality of art disciplines and tech components. Students may demonstrate their knowledge by using moveable virtual cards or other content, aligning multiple possible responses while interacting with their classmates. As part of the experience, users may be able to utilize innovation or invention as a solution to a challenge, analyze the art and technology components of emerging products, demonstrate critical thinking skills, and reinforce lessons learned in the virtual environment. An impact of the experience may include enhanced understanding of applications for art and technology, strengthened understanding of art and tech components for student solutions, enhanced ability to combine disciplines of science, technology, engineering, art, and mathematics (or STEAM disciplines).

Students may break into groups and enter their own lab where teams may be granted access to speak and collaborate to solve the challenge. They may receive prompts to spark the design thinking process and ideate possible solutions, completing a virtual storyboard using the techniques they have acquired. Additionally, students may be able to demonstrate a prototype by creating an image of their invention or innovation, using provided the virtual tools. A recording or photograph of the completed space will record their outcomes. As part of the experience, users may be able to practice creative problem solving through collaboration, apply skills learned in art and tech previous learning spaces, develop an interest in repeating the process for other challenges, exposure to de-siloed and integrated STEAM learning, and increase interest in potential careers in art and technology. An impact of the experience may include empowerment of student's ability to innovate and invent, confidence in personal potential for problem solving, confidence in utilizing design and critical thinking, increased analytical abilities, and enhanced value of collaboration.

In some examples, student teams may present, discuss and peer review each innovation and invention inside or outside the virtual environment (such as in a virtual presentation space). Educator time permitting, teams may choose to pursue development of their product. Goals of the presentation may include introducing students to explaining and presenting their innovations, learning from other student's projects and ideas, building enthusiasm for tackling new challenges, inspiring students to continue working on valuable ideas. Impacts of the experience may include increased ability to collaborate, building of team skills for exchanging ideas, and empowerment to pursue problem solving utilizing art and tech.

In some examples, a collaborative learning system may include a post-environment experience curriculum and content. Educators and students may be able to continue and build problem solving proficiency with the techniques and skills gained in the virtual environment with the follow up content. In follow up content, an educator can access many challenges based on, for example, the UN Global Goals and utilize the storyboard and art and tech cards and methodology utilized in the virtual environment.

### F. Additional Example Aspects

Disclosed herein are example aspects of a collaborative learning system. Any of the disclosed examples may be combined.

Example 1: A system for collaborative learning, the system comprising: a plurality of problem cards comprising a representation of a problem to be solved;
a plurality of technology cards comprising a representation of a technology; and
a plurality of art cards comprising a representation of an art production technique,
wherein one or more users identify a technology represented on one or more of the plurality of technology cards and an art production technique represented on one or more of the plurality of art cards to determine a solution to a problem represented on one or more of the plurality of problem cards.

Example 2: The system of Example 1 further comprising a combination board comprising:
a first area configured to receive one or more of the plurality of problem cards;
a second area configured to receive one or more of the plurality of technology cards; and
a third area configured to receive one or more of the plurality of art cards.

Example 3: The system of Example 2, wherein the second area comprises:
a first technology card location configured to receive one or more of the plurality of technology cards associated with a first user of the one or more users; and
a second technology card location configured to receive one or more of the plurality of technology cards associated with a second user of the one or more users.

Example 4: The system of Example 2, wherein the third area comprises:
a first art card location configured to receive one or more of the plurality of art cards associated with a first user of the one or more users; and
a second art card location configured to receive one or more of the plurality of art cards associated with a second user of the one or more users.

Example 5: The system of Example 1 further comprising a plurality of voting tokens.

Example 6: The system of Example 5, wherein the one or more users identifies the technology represented on one or more of the plurality of technology cards and the art production technique represented on one or more of the plurality of art cards by:
placing one or more voting tokens on the one or more of the plurality of technology cards; and
placing one or more voting tokens on the one or more of the plurality of art cards.

Example 7: The system of Example 1 further comprising a timer.

Example 8: The system of Example 7, wherein the one or more users determines the solution based on said technology and said art production technique within a period of time determined by the timer.

Example 9: A method of using a collaborative problem-solution board game, the method comprising:
determining one or more problem cards of a plurality of problem cards, wherein the one or more problem cards comprise a representation of a problem to solve;
distributing a plurality of technology cards among a plurality of players, wherein the one or more plurality of technology cards comprise a representation of a technology;
distributing a plurality of art cards among the plurality players, wherein the one or more plurality of art carts comprise a representation of an art production technique;
identifying one or more technology cards of the plurality of distributed technology cards to utilize in one or more proposals to solve the problem represented on the one or more problem cards;
identifying one or more art cards of the plurality of distributed art cards to utilize in the one or more proposals; and
determining a winning proposal of the one or more proposals.

Example 10: The method of Example 9 comprising determining a player category for each of a plurality of players, wherein the player category comprises at least one of a technology player and an art player.

Example 11: A method of collaborative learning in a virtual environment, the method comprising:
facilitating access to a plurality of users to a virtual environment;
displaying interactive educational content associated with a problem or a technology;
receiving a user interaction with the interactive educational content;
updating the virtual environment in response to receiving the user interaction;
displaying a virtual game associated with at least some of the educational content;
receiving a user interaction associated with the virtual game;
facilitating user access to a separate area of the virtual environment to allow group discussion of aspects of the virtual game.

Example 12: The method of Example 11, wherein the interactive educational content associated with the problem comprises at least one of: a video about the problem and a virtual activity.

Example 13: The method of Example 11, wherein the virtual activity comprises interacting with virtual content to enact aspects of the problem or a potential solution to the problem.

Example 14: The method of Example 11, wherein the problem comprises pollution.

Example 15: The method of Example 11, wherein the interactive educational content associated with the technology comprises at least one of: a video about the technology, an example display about the technology and a virtual activity.

Example 16: The method of Example 11, wherein the virtual activity comprises interacting with virtual content to interact with aspects of the technology.

Example 17: The method of Example 11, wherein the user interaction associated with the virtual game comprises a selection of art and technology content to combine in order to address a problem associated with virtual game.

Example 18: The method of Example 11, wherein the separate area comprises a private virtual space for a plurality of users that are a subset of the total number of users present in the virtual environment.

Example 19: The method of Example 18, wherein a plurality private virtual spaces are accessible by an educator user.

Example 20: The method of Example 11, wherein interactive content is displayed in a dedicated room of the virtual environment.

### G. Terminology

Many other variations than those described herein will be apparent from this disclosure. For example, depending on the embodiment, certain acts, events, or functions of any of the algorithms described herein can be performed in a different sequence, can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a hardware processor comprising digital logic circuitry, a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. A computing environment can include any type of computer system, including, but not limited to, a computer system based on a microprocessor, a mainframe computer, a digital signal processor, a portable computing device, a device controller, or a computational engine within an appliance, to name a few.

The steps of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC.

Conditional language used herein, such as, among others, “can,” “might,” “may,” “for example,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

Disjunctive language such as the phrase “at least one of X, Y and Z,” unless specifically stated otherwise, is to be understood with the context as used in general to convey that an item, term, etc. may be either X, Y, or Z, or a combination thereof. Thus, such conjunctive language is not generally intended to imply that certain embodiments require at least one of X, at least one of Y and at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others.

What is claimed is:

1. A system for collaborative learning, the system comprising:
a plurality of problem cards comprising a representation of a problem to be solved;
a plurality of technology cards comprising a representation of a technology; and
a plurality of art cards comprising a representation of an art production technique,
wherein one or more users identify a technology represented on one or more of the plurality of technology cards and an art production technique represented on one or more of the plurality of art cards to determine a solution to a problem represented on one or more of the plurality of problem cards.

2. The system of claim 1 further comprising a combination board comprising:
a first area configured to receive one or more of the plurality of problem cards;
a second area configured to receive one or more of the plurality of technology cards; and
a third area configured to receive one or more of the plurality of art cards.

3. The system of claim 2, wherein the second area comprises:
a first technology card location configured to receive one or more of the plurality of technology cards associated with a first user of the one or more users; and
a second technology card location configured to receive one or more of the plurality of technology cards associated with a second user of the one or more users.

4. The system of claim 2, wherein the third area comprises:
a first art card location configured to receive one or more of the plurality of art cards associated with a first user of the one or more users; and
a second art card location configured to receive one or more of the plurality of art cards associated with a second user of the one or more users.

5. The system of claim 1 further comprising a plurality of voting tokens.

6. The system of claim 5, wherein the one or more users identifies the technology represented on one or more of the plurality of technology cards and the art production technique represented on one or more of the plurality of art cards by:
placing one or more voting tokens on the one or more of the plurality of technology cards; and
placing one or more voting tokens on the one or more of the plurality of art cards.

7. The system of claim 1 further comprising a timer.

8. The system of claim 7, wherein the one or more users determines the solution based on said technology and said art production technique within a period of time determined by the timer.

9. A method of using a collaborative problem-solution board game, the method comprising:
determining one or more problem cards of a plurality of problem cards, wherein the one or more problem cards comprise a representation of a problem to solve;
distributing a plurality of technology cards among a plurality of players, wherein the one or more plurality of technology cards comprise a representation of a technology;
distributing a plurality of art cards among the plurality players, wherein the one or more plurality of art carts comprise a representation of an art production technique;
identifying one or more technology cards of the plurality of distributed technology cards to utilize in one or more proposals to solve the problem represented on the one or more problem cards;
identifying one or more art cards of the plurality of distributed art cards to utilize in the one or more proposals; and
determining a winning proposal of the one or more proposals.

10. The method of claim 9 comprising determining a player category for each of a plurality of players, wherein the player category comprises at least one of a technology player and an art player.

11. A method of collaborative learning in a virtual environment, the method comprising:
facilitating access of a plurality of users to a virtual environment;
displaying interactive educational content associated with a problem or a technology;
receiving a user interaction with the interactive educational content;
updating the virtual environment in response to receiving the user interaction;
displaying a virtual game associated with at least some of the educational content;
receiving a user interaction associated with the virtual game; and
facilitating user access to a separate area of the virtual environment to allow group discussion of aspects of the virtual game.

12. The method of claim 11, wherein the interactive educational content associated with the problem comprises at least one of: a video about the problem or a virtual activity.

13. The method of claim 11, wherein the virtual activity comprises interacting with virtual content to enact aspects of the problem or a potential solution to the problem.

14. The method of claim 11, wherein the problem comprises pollution.

15. The method of claim 11, wherein the interactive educational content associated with the technology comprises at least one of: a video about the technology, an example display about the technology or a virtual activity.

16. The method of claim 11, wherein the virtual activity comprises interacting with virtual content to interact with aspects of the technology.

17. The method of claim 11, wherein the user interaction associated with the virtual game comprises a selection of art and technology content to combine in order to address a problem associated with virtual game.

18. The method of claim 11, wherein the separate area comprises a private virtual space for a plurality of users that are a subset of the total number of users present in the virtual environment.

19. The method of claim 18, wherein a plurality of private virtual spaces are accessible by an educator user.

20. The method of claim 11, wherein interactive content is displayed in a dedicated room of the virtual environment.
